(19) United States
(12) Patent Application Publication
(10) Pub. No.: US 2006/0133973 A1
(43) Pub. Date: Jun. 22, 2006

(54) Gas generator grate

(76) Inventor: Timo Saares, Tervola (FI)

Correspondence Address: BIRCH STEWART KOLASCH & BIRCH, PO BOX 747, FALLS CHURCH, VA, 22040-0747, US

(21) Appl. No.: 10/532,829

(22) PCT Filed: Oct. 21, 2003
(86) PCT No.: PCT/FI03/00778

§ 371 Date: Jan. 20, 2006

(30) Foreign Application Priority Data
May 13, 2004 (FI) 20021944

(51) Int. Cl. B01J 7/02

(52) U.S. Cl. 422/239

(57) ABSTRACT

A grate for a gas generator (7) adapted to operate in the gasifier of the gas generator so as to provide support to solid fuel fed thereon such as wood chips, peat, bark and hog fuel from forest harvesting and the like refuse fuel, the cross sections of the gasifier and thus also its grate being substantially circular in shape and the grate being equipped with substantially circular slots (9) having the same center point but a varying radius, whereby the circular slots are formed between the annular grate rings (3), and the grate having placed thereon a mass of balls (2) with a diameter larger than the width of the grate slots. The invention is implemented by way of mounting below the grate a member (4) that is rotatable about the center axis of the grate and is equipped with projections (6), at least some of which extending upward through the circular grate slots (9) to a level higher than the top level of the grate.

The invention relates to a grate for a gas generator adapted to operate in the gasifier of the gas generator so as to provide support to solid fuel fed thereon for combustion such as wood chips, peat, bark and hog fuel from forest harvesting and the like refuse fuel, the cross sections of the gasifier and thus also its grate being substantially circular in shape and the grate being equipped with substantially circular slots having the same center point but a varying radius, whereby the circular slots are formed between the annular grate rings, and the grate having placed thereon a mass of balls with a diameter larger than the width of the grate slots.

In fixed-bed gasification, one of the principal elements is the gasifier grate. In downward draft gasification a problem often arises in the combustion process from the buildup of the ash onto the grate, whereby the flow-through of the product gas is obstructed. An additional problem is caused by the fall-through of fuel into the ash collector before complete combustion of the fuel has occurred.

A solution to the above problem has been sought by virtue of a grate construction disclosed in EP patent application publication 0101143. In this construction onto the grate is placed a layer of balls and the grate is adapted rotatable. The friction of the balls against the inner wall of the gasifier vessel makes the balls move relative to each other. Moreover, the bearing assembly of the grate drive shaft is intentionally designed unstable such that the grate can vibrate and oscillate as it rotates. As a result, ash can fall down through the ball layer and the underlying grate, whereby the combustion process is improved.

However, the functionality of the arrangement described in the reference publication is unsatisfactory and difficult to optimize for a given combustion process. It is a function of the ball layer grate according to the invention to provide an improvement to the functionality of a gas generator. The grate in accordance with the invention is characterized in that below the grate is mounted a member that is rotatable about the center axis of the grate and is equipped with projections, at least some of which extending upward through the circular grate slots to a level higher than the top level of the grate.

A preferred embodiment of the grate according to the invention is characterized in that the rotatable member is a rod-supported rake and that the rake projections are pegs extending upward from the rake rod so far that the tips of the pegs reach higher than the top surface of the grate rings.

Another preferred embodiment of the grate according to the invention is characterized in that the grate rings are connected to each other by a support structure that is situated above the top surface of the grate and simultaneously provides two or more compartments for the balls.

A still another preferred embodiment of the grate according to the invention is characterized in that the grate ring support structure comprises two planar members orthogonally crossed with each other so as to form four compartments for the balls, whereby the height of the planar members is selected to be greater than one and half times the ball diameter.

Accordingly, the goal of the invention is achieved by way of using a grate comprising circular grate rings, a rotatable rake with poking pegs reaching higher than the grate top surface, and a bed of balls. The bed of balls is agitated with the help of the rake peg tips. The speed of rake rotation is controlled according to the intensity of the combustion process, that is, the required process output. The balls provide a suitable delay for the downfall of the unburnt fuel so that the combustion process can reach completion. With the movement of the rake and its poking pegs, the bails agitate the aggregated bed of ash thereby consistently forcing the ash to fall through the grate. Thus, also unobstructed pass-through of the product gas is secured.

In the following, the invention is examined-in more detail with the help of a preferred exemplary embodiment by making reference to the attached drawings in which

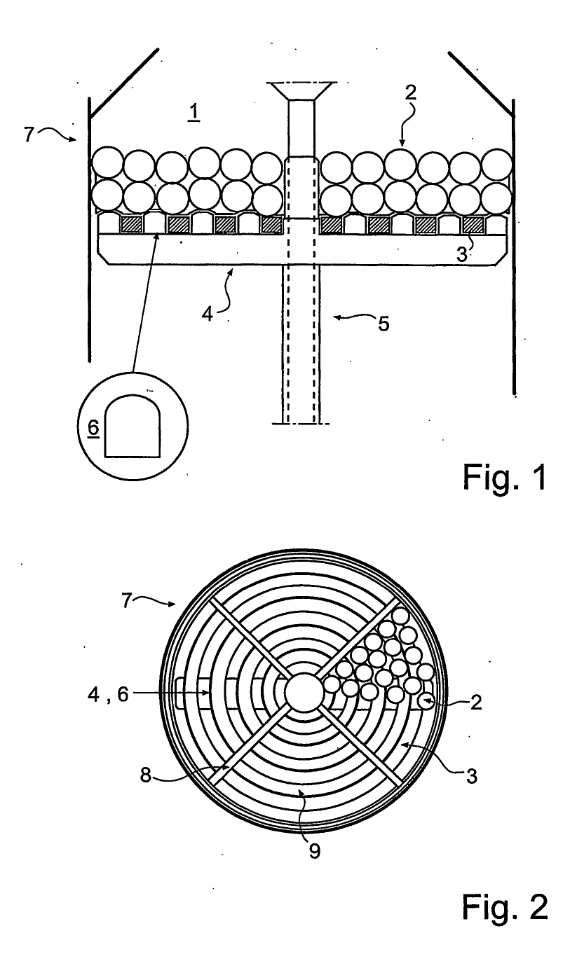

FIG. 1 shows a vertically sectional view of the grate portion of a gas generator; and

FIG. 2 shows a top view of the grate construction of FIG. 1.

Referring to FIG. 1, therein is shown a vertically sectional view of the grate portion of a gas generator 7 implementing a ball grate construction according to the invention. The grate is formed by concentric grate rings 3 spaced apart from each other by circular slots 9 (FIG. 2). In the exemplary embodiment discussed herein, two layers of balls 2 are used. The balls can be made from a metal such as steel or a ceramic material. In order to prevent the balls from falling through the grate slots, the diameter of the balls must be greater than the width of the circular slots between the grate rings. During operation, onto the ball bed is fed the material to be combusted in the gas generator, such as wood chips, peat, hog fuel from forest harvesting, saw dust or sorted municipal waste.

Below the grate is mounted a rotatable rake 4 that is connected to a drive shaft and in principle comprises an elongated rod. The rotary rake 4 carries pegs 6 reaching upward through the circular slots 9 of the grate. The tips of pegs 6 are adapted to reach higher than the top surface of the grate. Advantageously, the tips of the pegs 6 are rounded as shown in the enlarged-scale detail view of FIG. 1. During the rotation of rake 4, the pegs elevate the balls coinciding with their tips thus causing agitation of the ball bed.

As shown in FIG. 2, the balls 2 are trapped in compartments formed by the support structure 8 of the grate rings 3. As the wall height of the support structure 8 is made greater than one and half times the ball diameter, at least two layers of balls stay put in the compartments. While the embodiment shown in FIG. 2 has four compartments, there is no basic limitation as to the number of compartments. The division into compartments implemented with the help of the walls of grate support structure 8 serves to prevent excessive movements of the balls with the poking pegs as the rake is rotated. Obviously, the number of layers in the ball bed is by no means limited to given number, but instead, either one or more layers may be used. For greater clarity, in FIG. 2 only a portion of one compartment is shown filled with balls. In an actual situation, the entire surface area of the grate is filled with balls.

A ball grate in accordance with the invention functions by way of having the ball mass agitated with the help of the pegs 6 of rotary rake poking through the grate slots. The rotating speed of the rake is controlled in proportion to the combustion process intensity, that is, required process output. The balls provide a suitable delay for the downfall of the unburnt fuel so that the combustion process can reach completion. With the movement of the ball mass actuated by the rake and its poking pegs, the balls agitate the aggregated bed of ash thus consistently forcing the ash to fall through the grate. Simultaneously, unobstructed pass-through of the product gas is secured.

To a person skilled in the art it is obvious that the invention is not limited to the exemplary embodiment described above, but rather, can be varied within the scope and spirit of the appended claims. For instance, the rotary movement of the rake can be made steplessly adjustable or controllable.

1. A grate for a gas generator (7) adapted to operate in the gasifier of the gas generator so as to provide support to solid fuel fed thereon for combustion such as wood chips, peat, bark and hog fuel from forest harvesting and the like refuse fuel fed thereon, the cross sections of the gasifier and thus also its grate being substantially circular in shape and the grate being equipped with substantially circular slots (9) having the same center point but a varying radius, whereby the circular slots are formed between the annular grate rings (3), and the grate having placed thereon a mass of balls (2) with a diameter larger than the width of the grate slots, characterized in that below the grate is mounted a member (4) that is rotatable about the center axis of the grate and is equipped with projections (6), at least some of which extending upward through the circular grate slots (9) to a level higher than the top level of the grate.

2. The grate of claim 1, characterized in that the rotatable member is a rod-supported rake (4) and that the rake projections are pegs (6) extending upward from the rake rod so far that the tips of the pegs reach higher than the top surface of the grate rings (3).

3. The grate of claim 1, characterized in that the grate rings (3) are connected to each other by a support structure (8) that is situated above the top surface of the grate and simultaneously provides two or more compartments for the balls.

4. The grate of claim 3, characterized in that the support structure (8) of the grate rings (3) comprises two planar members orthogonally crossed with each other so as to form four compartments for the balls (2), whereby the height of the planar members is selected to be greater than one and half times the ball diameter.

5. The grate of claim 1, characterized in that the balls (2) are made from a metal such as steel or a ceramic material.

6. The grate of claim 1, characterized in that the rotating speed of rake (4) is adjustable or automatically controllable.

7. The grate of claim 2, characterized in that the grate rings (3) are connected to each other by a support structure (8) that is situated above the top surface of the grate and simultaneously provides two or more compartments for the balls.

8. The grate of claim 2, characterized in that the balls (2) are made from a metal such as steel or a ceramic material.

9. The grate of claim 3, characterized in that the balls (2) are made from a metal such as steel or a ceramic material.

10. The grate of claim 4, characterized in that the balls (2) are made from a metal such as steel or a ceramic material.

11. The grate of claim 2, characterized in that the rotating speed of rake (4) is adjustable or automatically controllable.

12. The grate of claim 3, characterized in that the rotating speed of rake (4) is adjustable or automatically controllable.

13. The grate of claim 4, characterized in that the rotating speed of rake (4) is adjustable or automatically controllable.
